(19) United States
(12) Patent Application Publication
(10) Pub. No.: US 2012/0313850 A1
(43) Pub. Date: Dec. 13, 2012

(54) DISPLAY APPARATUS

(75) Inventors: Daisuke ISHIDA, Fujimi (JP); Yasushi MIZOGUCHI, Suwa (JP)

(73) Assignee: SEIKO EPSON CORPORATION, Tokyo (JP)

(21) Appl. No.: 13/487,539

(22) Filed: Jun. 4, 2012

(30) Foreign Application Priority Data
Jun. 8, 2011 (JP) 2011-128067

(51) Int. Cl. G02B 26/10; G09G 5/00; G09G 5/10

(52) U.S. Cl. 345/156; 359/212.2; 345/691

(57) ABSTRACT

A display apparatus includes: a light emitting unit which emits light; a light scanning unit which includes a light reflector and scans the light in first and second directions; an amplitude changing unit which changes an amplitude of the swing of the light reflector; and a light emitting control unit which adjusts an amount of light of the light emitting unit, wherein the amplitude changing unit allows a first state where the light is scanned in a first region of the display surface and a second state where the light is scanned on the first region and a second region of the display surface is switched, and wherein the light emitting control unit allows an amount of light per unit area of the first region in the first state and an amount of light per unit area of the first region in the second state to be equalized.

### BACKGROUND

1. Technical Field

The invention relates to a display apparatus.

2. Related Art

For example, as a head-up display (HUD) which displays images regarding to various types of information of meters, navigation, or the like of a car on a windshield of a vehicle, there is known a head-up display using a display apparatus referred to as a scan type projection system (Laser Scan Projection: LSP) which displays an image by two-dimensionally scanning light beams on a screen (for example, refer to JP-A-2009-137491). In such a display apparatus, a light scanner which one-dimensionally or two-dimensionally scans light beams is installed. For example, the display apparatus disclosed in JP-A-2009-137491 includes a light scanner which two-dimensionally scans light beams by allowing a mirror portion to rotate (swing) around two rotation axes which are perpendicular to each other.

However, with respect to such a display apparatus, since a scanning range (for example, in JP-A-2009-137491, the amplitude of rotation of the mirror portion) of the light scanner is usually constant, the shape and size of an image renderable region as a region where an image can be displayed are constant.

Therefore, there is a case where an area of a region where no image is formed in the image renderable region increases according to a shape (outer appearance) or a size of a to-be-displayed image. In this case, the ratio (so-called time aperture ratio) of a period when image rendering is performed in one frame decreases. Such a decrease in the time aperture ratio denotes a deterioration in energy efficiency. Particularly, in the display apparatus such as an HUD, although an opportunely necessary image (for example, an image notifying a danger) is displayed in a region different from the region where a usually displayed image (for example, an image representing a speed meter) is displayed, the image non-displayed period of the region where the necessary image is displayed at the appropriate time is relatively long. Therefore, the energy efficiency greatly decreases, and power consumption increases.

### SUMMARY

An advantage of some aspects of the invention is to provide a display apparatus capable of suppressing power consumption. An aspect of the invention is directed to a display apparatus including: a light emitting unit which emits light; a light scanning unit which includes at least one light reflector reflecting light emitted from the light emitting unit and being swingably installed around a swing axis, scans the light reflected by the light reflector on a display surface where an image is to be displayed in a first direction, and scans in a second direction perpendicular to the first direction at a speed lower than a scanning speed of the first direction; an amplitude changing unit which changes an amplitude of the swing of the light reflector; and a light emitting control unit which adjusts a light emitting timing of the light emitting unit and an amount of light emitted from the light emitting unit, wherein the amplitude changing unit changes the amplitude of the swing of the light reflector, so that a first state where the light is scanned in a first region of the display surface and a second state where the light is scanned on the first region and a second region different from the first region of the display surface is switched over each other, and wherein the light emitting control unit allows an amount of light per unit area of the first region in the first state and an amount of light per unit area of the first region in the second state to be equalized by adjusting the amount of light emitted from the light emitting unit.

According to the display apparatus, it is possible to suppress the amplitude of the swing of the light reflector so that the image renderable region is enlarged only in the necessary case and the image renderable region reaches the minimum limit if necessary in the other cases. Therefore, it is possible to suppress the power consumption in comparison with a case where the amplitude of the swing of the light reflector is constant. In the display apparatus according to the aspect of the invention, it is preferred that the light emitting control unit allows an resolution of an image displayed on the first region in the first state and a resolution of an image displayed on the first region in the second state to be equalized by adjusting the light emitting timing of the light emitting unit. According to this configuration, it is possible to reduce a change in resolution of the image displayed in the first region at the time of switching between the first and second states. In the display apparatus according to the aspect of the invention, it is preferred that an image displayed in the first region in the first state and an image displayed in the first region in the second state are the same in type, and the image displayed in the first region and an image displayed in the second region are different from each other in type.

According to this configuration, in the second state, it is possible to highlight the image displayed in the second region in comparison with the image displayed in the first region. In the display apparatus according to the aspect of the invention, it is preferred that the image displayed in the first region includes an image representing information on a moving state of a moving body having the display apparatus, and the image displayed in the second region includes an image representing information on an external situation of the moving body.

According to this configuration, in the first and second states, it is possible to provide the information on the moving state of the moving body having the display apparatus, and in the second state, it is possible to notify the information on the external situation of the moving body.

In the display apparatus according to the aspect of the invention, it is preferred that the display apparatus further includes a situation sensing unit which senses the external situation of the moving body, and the amplitude changing unit switches the first state and the second state based on a result of the sensing of the situation sensing unit.

According to this configuration, it is possible to sense the external situation of the moving body and to notify the result of the sensing.

In the display apparatus according to the aspect of the invention, it is preferred that the amplitude changing unit changes an amplitude of the swing of the light reflector which scans the light in the first direction.

According to this configuration, it is possible to change the length of the image renderable region in the first direction. In the display apparatus according to the aspect of the invention, it is preferred that the amplitude changing unit changes an amplitude of the swing of the light reflector which scans the light in the second direction.

According to this configuration, it is possible to change the length of the image renderable region in the second direction. In the display apparatus according to the aspect of the invention, it is preferred that the light scanning unit includes a driving unit which swings the light reflector by supplying a periodically varying current or voltage, and the amplitude changing unit changes an amplitude of the swing of the light reflector by adjusting a magnitude and a frequency of the current or voltage supplied to the driving unit. According to this configuration, it is possible to relatively simply and securely change the amplitude of the swing of the light reflector.

In the display apparatus according to the aspect of the invention, it is preferred that the light emitting unit emits laser beams.

According to this configuration, since an optical system such as lenses for forming parallelized light beams can be simplified and miniaturized, it is possible to miniaturize the light emitting unit, and furthermore, it is possible to miniaturize the image forming apparatus.

### BRIEF DESCRIPTION OF THE DRAWINGS

The invention will be described with reference to the accompanying drawings, wherein like numbers reference like elements.

FIG. 1 is a schematic diagram illustrating a display system (head-up display system) including a display apparatus (head-up display) according to a first embodiment of the invention.

FIG. 2 is a schematic diagram illustrating the display system illustrated in FIG. 1.

FIG. 3 is a schematic diagram illustrating a schematic configuration of the display apparatus included in the display system illustrated in FIG. 1.

FIG. 4 is a partial cross-sectional perspective diagram illustrating a light scanner included in a light scanning unit of the display apparatus illustrated in FIG. 3.

FIGS. 5A and 5B are cross-sectional diagrams illustrating operations of the light scanner illustrated in FIG. 4.

FIG. 6 is a block diagram illustrating a control system (operation control unit, light scanning unit, and light source unit) of the display apparatus illustrated in FIG. 3.

FIGS. 7A and 7B are diagrams illustrating operations of the display apparatus illustrated in FIG. 3 (diagrams illustrating an image renderable region, an image rendering region, and an image).

FIGS. 8A and 8B are diagrams illustrating the image renderable region illustrated in FIGS. 7A and 7B.

FIG. 9 is a graph illustrating a change of a deflection angle of a movable plate of the light scanner (vertical scanning light scanner) of the display apparatus illustrated in FIG. 3.

FIG. 10 is a graph illustrating a change (first state) of a deflection angle of a movable plate of the light scanner (horizontal scanning light scanner) of the display apparatus illustrated in FIG. 3.

FIG. 11 is a graph illustrating a change (second state) of a deflection angle of a movable plate of the light scanner (horizontal scanning light scanner) of the display apparatus illustrated in FIG. 3.

FIGS. 12A and 12B are diagrams illustrating operations of a display apparatus according to a second embodiment of the invention (diagrams illustrating an image renderable region, an image rendering region, and an image).

FIGS. 13A and 13B are diagrams illustrating the image renderable region illustrated in FIGS. 12A and 12B.

FIG. 14 is a schematic plan diagram illustrating a light scanner of a projector included in a display apparatus according to a third embodiment of the invention.

FIG. 15 is a cross-sectional diagram taken along line XV-XV of FIG. 14.

### DESCRIPTION OF EXEMPLARY EMBODIMENTS

Hereinafter, exemplary embodiments of a display apparatus according to the invention will be described with reference to the attached drawings.

### First Embodiment

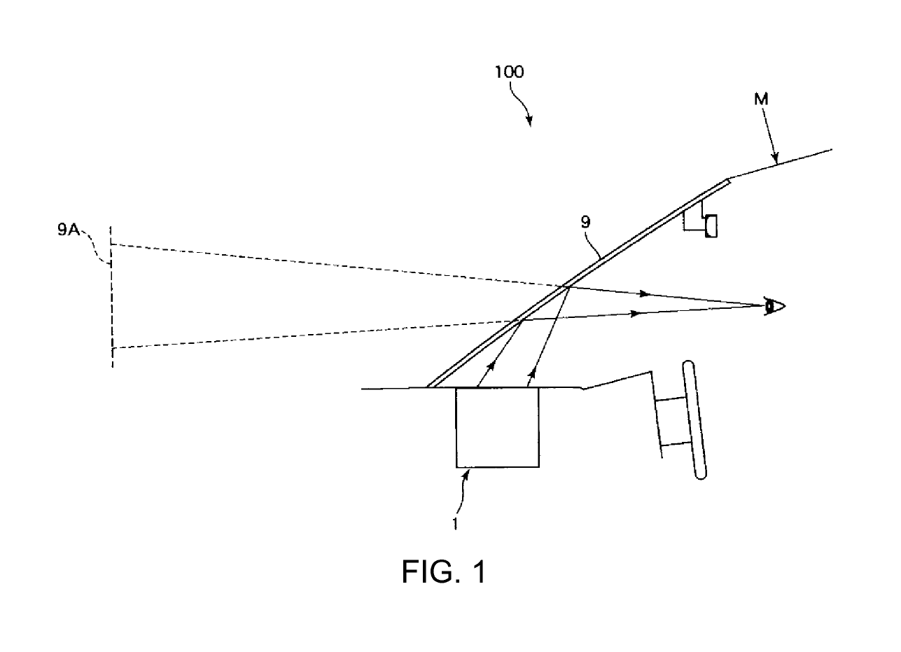

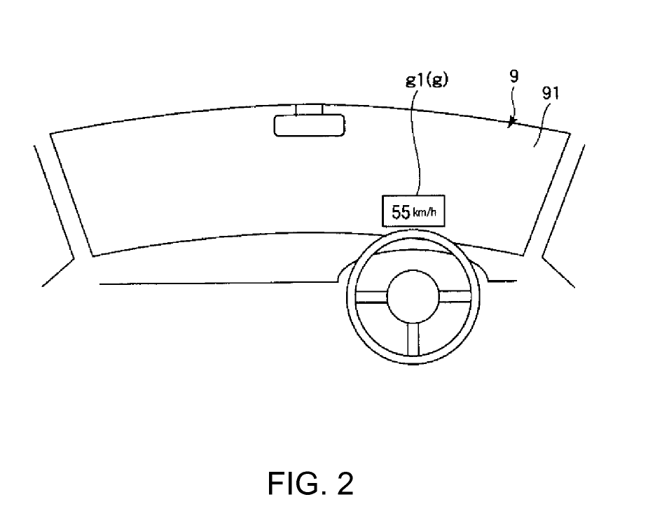

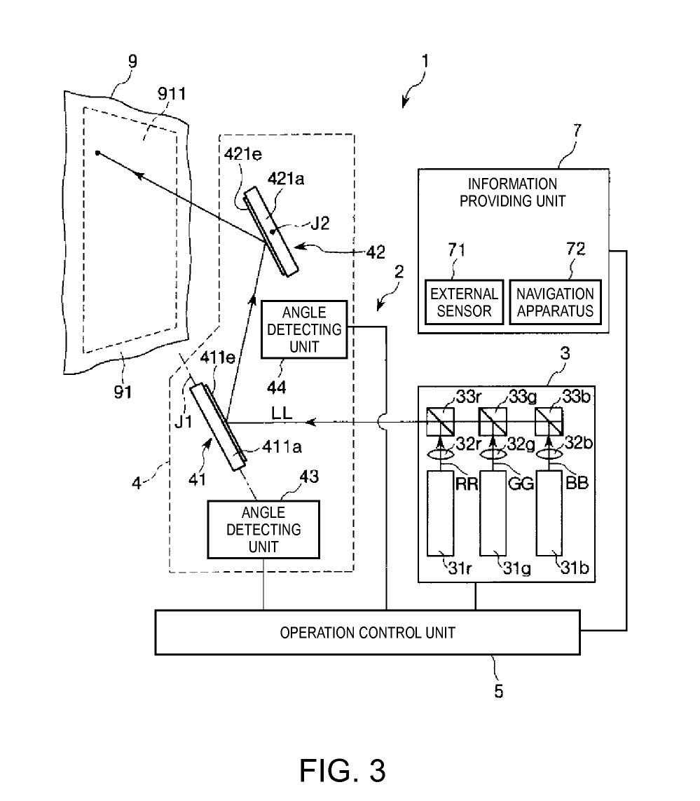

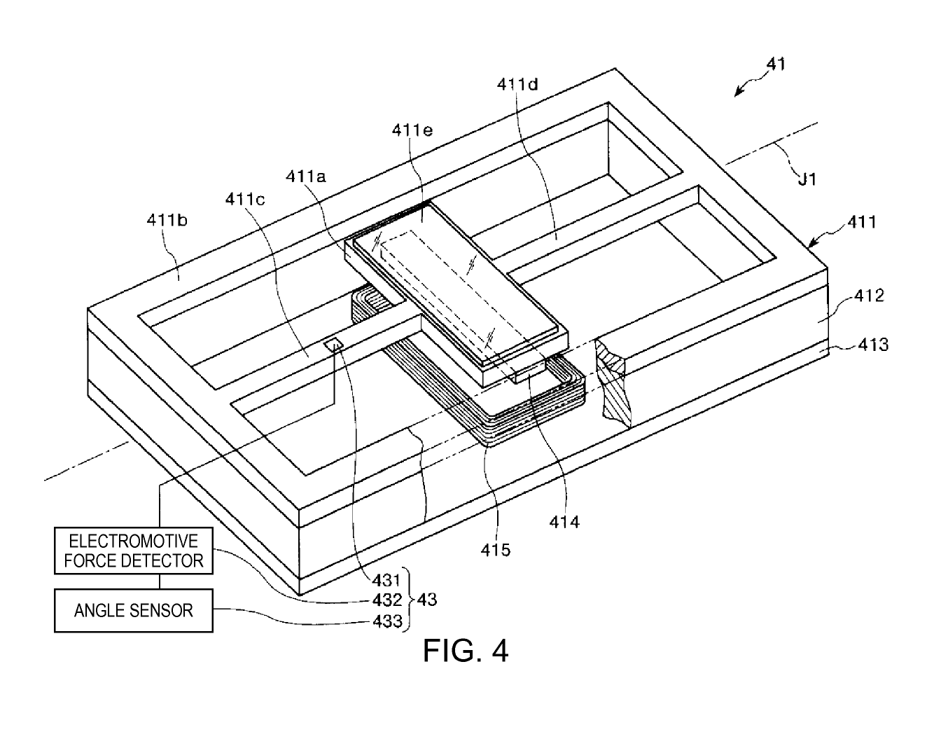

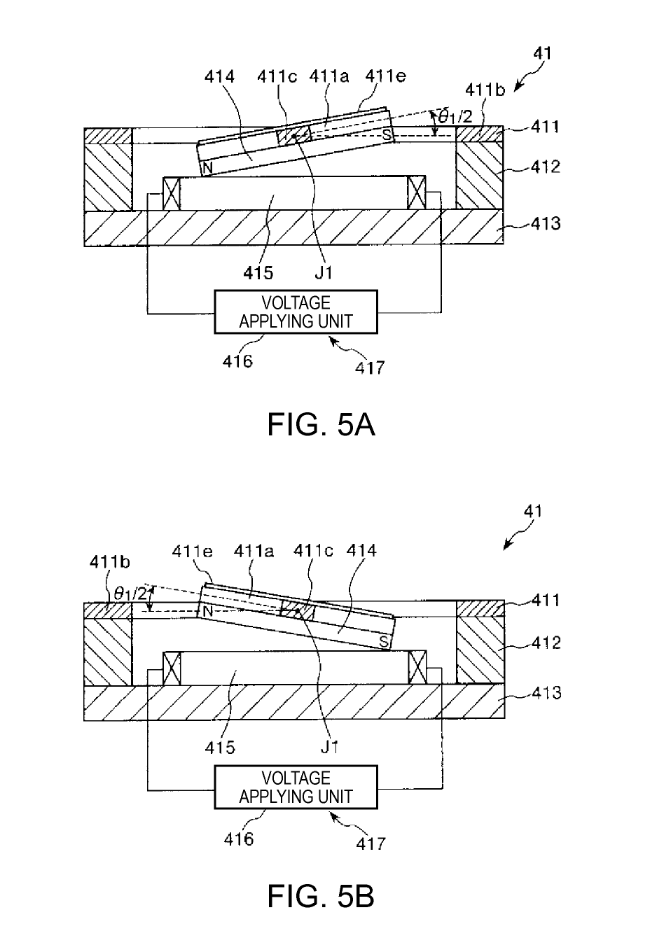

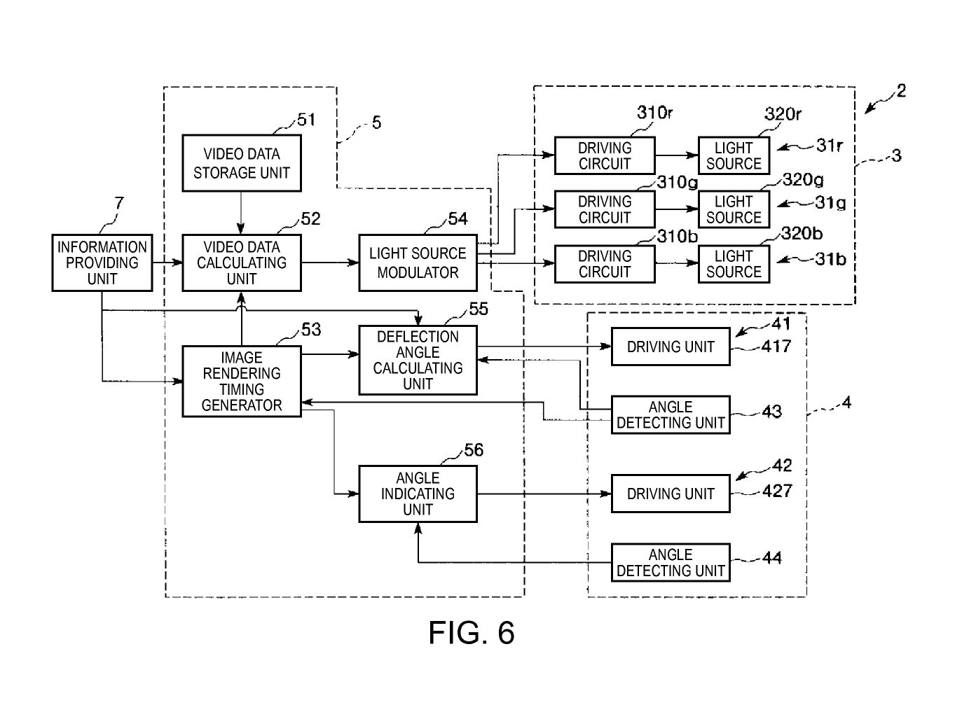

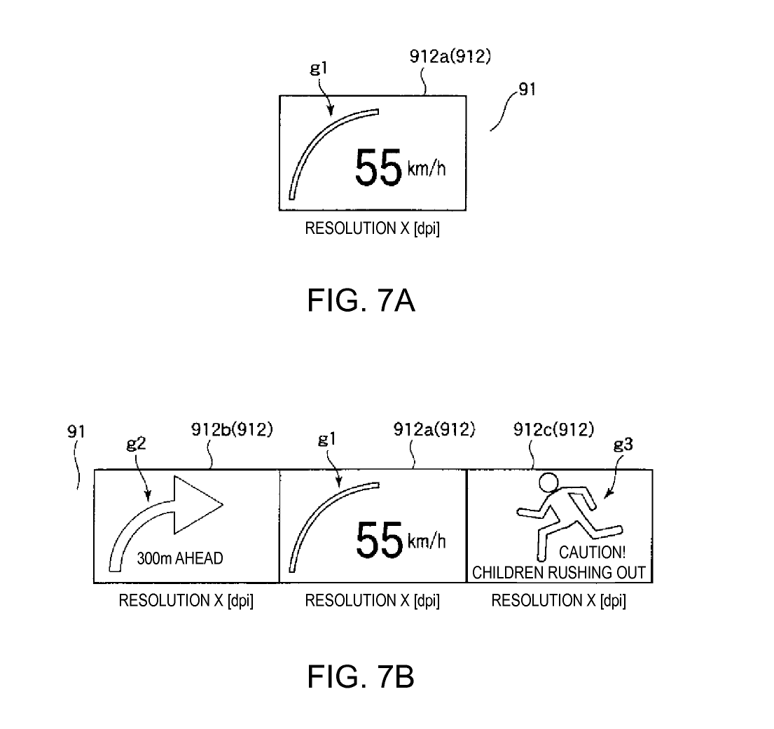

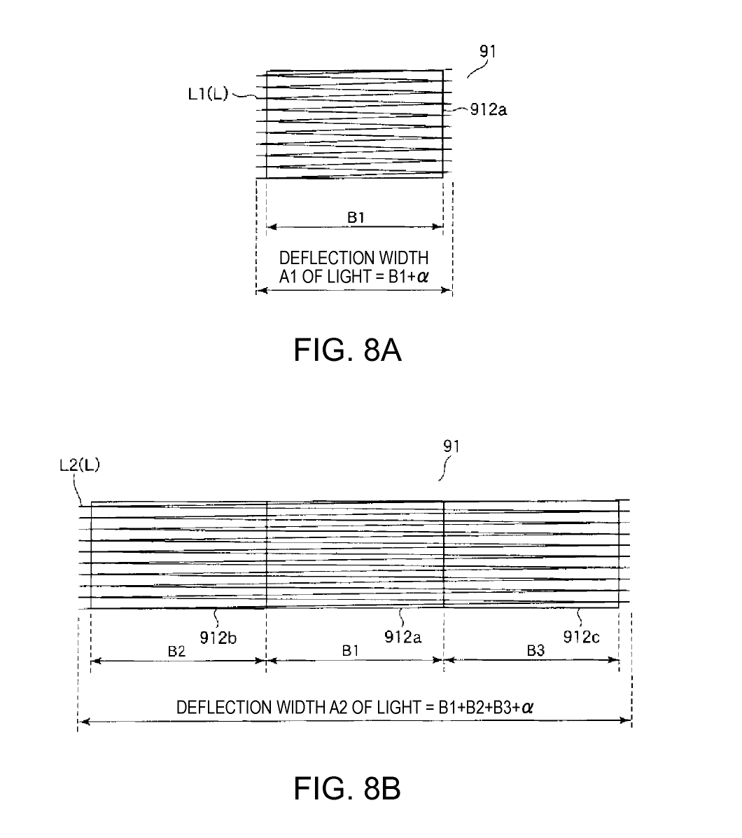

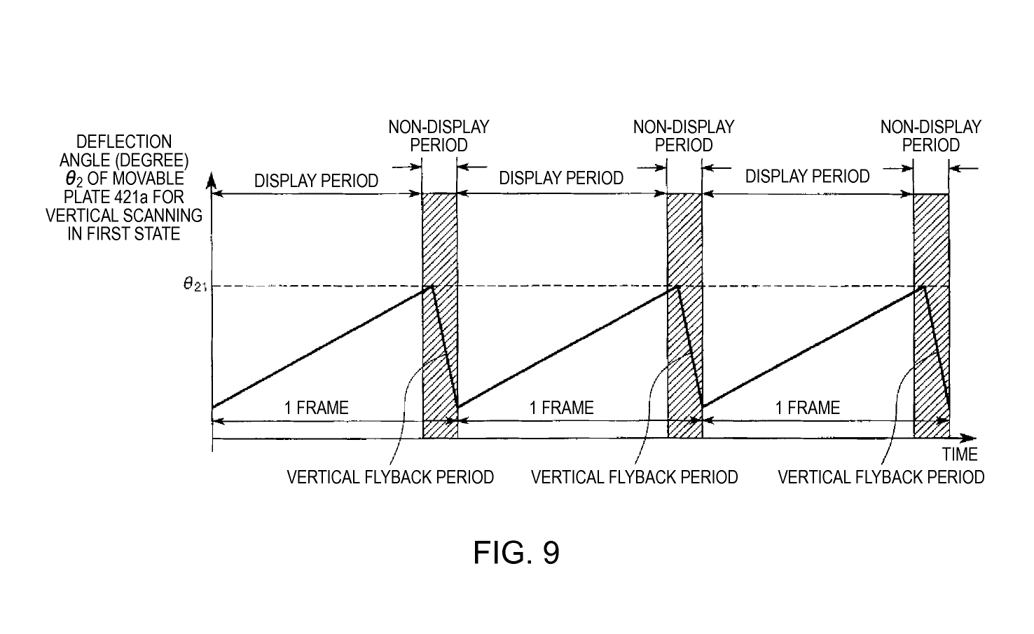

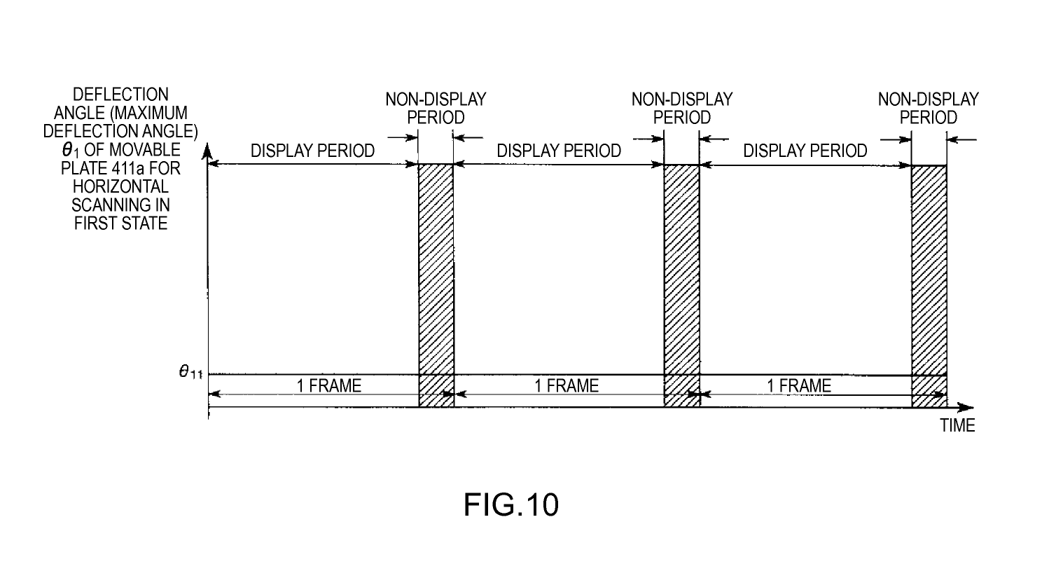

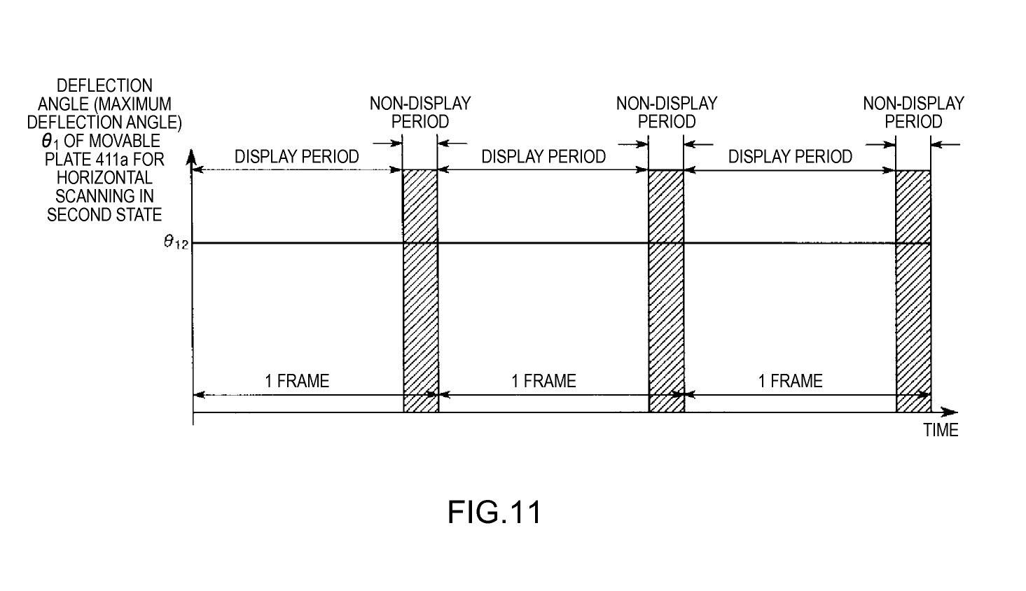

FIG. 1 is a schematic diagram illustrating a display system (head-up display system) including a display apparatus (head-up display) according to a first embodiment of the invention. FIG. 2 is a schematic diagram illustrating the display system illustrated in FIG. 1. FIG. 3 is a schematic diagram illustrating a schematic configuration of the display apparatus included in the display system illustrated in FIG. 1. FIG. 4 is a partial cross-sectional perspective diagram illustrating a light scanner included in a light scanning unit of the display apparatus illustrated in FIG. 3. FIGS. 5A and 5B are cross-sectional diagrams illustrating operations of the light scanner illustrated in FIG. 4. FIG. 6 is a block diagram illustrating a control system (operation control unit, light scanning unit, and light source unit) of the display apparatus illustrated in FIG. 3. FIGS. 7A and 7B are diagrams illustrating operations of the display apparatus illustrated in FIG. 3 (diagrams illustrating an image renderable region, an image rendering region, and an image). FIGS. 8A and 8B are diagrams illustrating the image renderable region illustrated in FIGS. 7A and 7B. FIG. 9 is a graph illustrating a change of a deflection angle of a movable plate of the light scanner (vertical scanning light scanner) of the display apparatus illustrated in FIG. 3. FIG. 10 is a graph illustrating a change (first state) of a deflection angle of a movable plate of the light scanner (horizontal scanning light scanner) of the display apparatus illustrated in FIG. 3. FIG. 11 is a graph illustrating a change (second state) of a deflection angle of a movable plate of the light scanner (horizontal scanning light scanner) of the display apparatus illustrated in FIG. 3. In addition, hereinafter, for the convenience of description, the upper, lower, right, and left sides of FIGS. 5A and 5B are referred to as “upper”, “lower”, “right”, and “left”, respectively.

A display system 100 illustrated in FIG. 1 includes a display apparatus 1 installed in a moving body M and displays an image by allowing the display apparatus 1 to project light beams on a windshield (front window) 9 of the moving body M.

In the embodiment, the moving body M is a vehicle. A manipulator of the moving body M may visually recognize an image (image g illustrated in FIG. 2) as a virtual image on a virtual image plane 9A located in front of the windshield 9.

As illustrated in FIG. 3, the display apparatus 1 is configured to include a projector 2 which displays (renders) the image by scanning light beams on a display surface 91 of the windshield 9, an operation control unit 5 which controls driving of the projector 2, and an information providing unit 7.

In the display apparatus 1, the operation control unit 5 controls operations of the projector 2 based on information from the information providing unit 7 to display the image on the display surface 91 of the windshield 9.

Hereinafter, components constituting the display apparatus 1 will be described sequentially in detail.

### Projector

First, the projector 2 will be described.

The projector 2 is configured to scan light beams on an image rendering region 911 formed on the display surface 91 so as to display the image.

More specifically, as illustrated in FIG. 1, the projector 2 includes a light source unit (light emitting unit) 3 which emits light beams and alight scanning unit 4 which scans light beams emitted from the light source unit 3 on the display surface 91.

### Light Source Unit (Light Emitting Unit)

As illustrated in FIG. 3, the light source unit 3 includes laser sources 31r, 31g, and 31b of the respective colors, collimator lenses 32r, 32g, and 32b installed corresponding to the laser sources 31r, 31g, and 31b of each color, and dichroic mirrors 33r, 33g, and 33b.

In addition, each of the laser sources 31r, 31g, and 31b of each color includes a corresponding driving circuit of driving circuits 310r, 310g, and 310b and a corresponding light source of a red light source 320r, a green light source 320g, and a blue light source 320b (refer to FIG. 6) and, as illustrated in FIG. 3, each of the laser sources 31r, 31g, and 31b emits respective laser beams of red, green, and blue laser beams RR, GG, and BB. Each of the laser beams RR, GG, and BB is emitted in the state that the laser beam is modulated according to a driving signal transmitted from a light source modulator 54, described later, of the operation control unit 5 and is parallelized to become a thin beam by each of the collimator lenses 32r, 32g, and 32b which are collimating optical devices. Each of the dichroic mirrors 33r, 33g, and 33b has a characteristic of reflecting each of the red laser beam RR, the green laser beam GG, and the blue laser beam BB, and the laser beams RR, GG, and BB of each color are combined, so that one laser beam (light) LL is emitted.

Furthermore, collimator mirrors maybe used as substitutes for the collimator lenses 32r, 32g, and 32b, and even in this case, a thin beam as a parallel light flux may be formed. In addition, in the case where parallel fluxes are emitted from the laser sources 31r, 31g, and 31b of each color, the collimator lenses 32r, 32g, and 32b may be omitted. Moreover, the laser sources 31r, 31g, and 31b may be substituted with light sources such as light emitting diodes which generate the same light fluxes.

In addition, in FIG. 3, the order of the laser sources 31r, 31g, and 31b of each color, the collimator lenses 32r, 32g, and 32b, and the dichroic mirrors 33r, 33g, and 33b is an example in all respects. Therefore, under the condition that a combination of colors (red corresponds to the laser source 31r, the collimator lens 32r, the dichroic mirror 33r; green corresponds to the laser source 31g, the collimator lens 32g, the dichroic mirror 33g; and blue corresponds to the laser source 31b, the collimator lens 32b, the dichroic mirror 33b) is maintained, the order thereof may be arbitrarily set. For example, a combination of blue, red, and green as an order according to the closeness to the light scanning unit 4 may also be available.

Since the light source unit 3 emits the laser beam as described above, although a deflection angle of light reflector 411e is changed as described later, it is possible to simply prevent an image from being blurred. In addition, the projector 2 using the light source unit 3 can perform proximity projection in a focus-free manner and can adjust a projection position to an arbitrary position without limitation to the installation position. In addition, if the laser beam is used, since the lenses or the like for forming parallelized light beams can be simplified and miniaturized, it is possible to miniaturize the light emitting unit, and furthermore, it is possible to miniaturize the display apparatus 1.

### Light Scanning Unit

Next, the light scanning unit 4 will be described.

The light scanning unit 4 two-dimensionally scans the laser beam LL emitted from the light source unit 3 on the display surface 91 by scanning in the horizontal direction (first direction) (horizontal scanning: main scanning) and scanning in the vertical direction (second direction perpendicular to the first direction) (vertical scanning: sub scanning) at a scanning speed (second speed) lower than the horizontal scanning speed (first speed).

The light scanning unit 4 includes a light scanner (first direction scanning unit) 41 as a horizontal scanning mirror which scans the laser beam LL emitted from the light source unit 3 on the display surface 91 in the horizontal direction, an angle detecting unit (behavior detecting unit) 43 which detects an angle (behavior) of a later-described movable plate 411a of the light scanner 41, a light scanner (second direction scanning unit) 42 as a vertical scanning mirror which scans the laser beam LL emitted from the light source unit 3 on the display surface 91 in the vertical direction, and an angle detecting unit (behavior detecting unit) 44 which detects an angle (behavior) of a later-described movable plate 421a of the light scanner 42.

Hereinafter, although the configurations of the light scanners 41 and 42 are to be described, since the light scanners 41 and 42 have the same configuration, hereinafter, the light scanner 41 is representatively described, and the description of the light scanner 42 is omitted.

As illustrated in FIG. 4, the light scanner 41 is a light scanner of a so-called one-degree-of-freedom vibration system (one-dimensional scanning) and includes a substrate 411, an opposite substrate 413 which is installed to face a lower surface of the substrate 411, and a spacer member 412 which is installed between the substrate 411 and the opposite substrate 413.

The substrate 411 includes a movable plate 411a, a supporting portion 411b which rotatably supports the movable plate 411a, and a pair of connection portions 411c and 411d which connect the movable plate 411a and the supporting portion 411b. In other words, it may be stated that the supporting portion 411b supports the pair of the connection portions 411c and 411d, and it may be stated that the supporting portion 411b supports the movable plate 411a through the pair of the connection portions 411c and 411d.

The movable plate 411a is substantially rectangular as seen in plan view. A light reflector (mirror) 411e having a light reflection property is installed on the upper surface of the movable plate 411a. The light reflector 411e is made of, for example, a metal film such as Al and Ni. In addition, a permanent magnet 414 is installed on a lower surface of the movable plate 411a.

The supporting portion 411b is installed to surround the circumference of the movable plate 411a as the movable plate 411a is seen in plan view. In other words, the supporting portion 411b has a shape of a frame, and the movable plate 411a is located inside thereof.

In the left side of the movable plate 411a, the connection portion 411c connects the movable plate 411a and the supporting portion 411b; and in the right side of the movable plate 411a, the connection portion 411d connects the movable plate 411a and the supporting portion 411b.

Each of the connection portions 411c and 411d has a shape of a rectangle. In addition, each of the connection portions 411c and 411d is elastically deformable. The pair of the connection portions 411c and 411d are concentrically installed, and the movable plate 411a rotates (swings or oscillates) around the axis (hereinafter, referred to as a “rotation central axis (swing axis or oscillating axis) J1”) with respect to the supporting portion 411b.

The substrate 411 is made of, for example, silicon as a main component, and the movable plate 411a, the supporting portion 411b, and the connection portions 411c and 411d are integrally formed. In this manner, silicon is used as a main component, so that it is possible to obtain excellent rotation characteristic and excellent durability. In addition, since silicon can be processed in a fine process, if the substrate 411 is made of silicon as a main component, it is possible to obtain excellent dimensional accuracy of the substrate 411 and excellent vibration characteristic of the light scanner 41. In addition, it is possible to miniaturize the light scanner 41.

The spacer member 412 has a shape of a frame, and an upper surface thereof is in contact with a lower surface of the substrate 411. In addition, the spacer member 412 has substantially the same shape as that of the supporting portion 411b as seen in plan view in the plate thickness direction of the movable plate 411a. The spacer member 412 is made of, for example, various kinds of glass, various kinds of ceramic, silicon, SiO₂, or the like.

Furthermore, a method of attaching the spacer member 412 to the substrate 411 is not particularly limited. For example, the spacer member 412 may be attached to the substrate 411 by using a separate member such as an adhesive, and direct bonding, anodic bonding, or the like may be used according to a constituting material or the like of the spacer member 412. Similarly to the spacer member 412, the opposite substrate 413 is made of, for example, various kinds of glass, silicon, SiO₂, or the like. A coil 415 is installed in a portion facing the movable plate 411a, which is an upper surface of the opposite substrate 413.

The permanent magnet 414 has a shape of a plate bar and is installed along the lower surface of the movable plate 411a. The permanent magnet 414 is magnetized in the direction perpendicular to the rotation central axis J1 as the movable plate 411a is seen in plan view. In other words, the permanent magnet 414 is installed so that a segment connecting two poles (S and N poles) is perpendicular to the rotation central axis J1.

The permanent magnet 414 is not particularly limited, and for example, a neodymium magnet, a ferrite magnet, a samarium-cobalt magnet, an alnico magnet, or the like may be used.

The coil 415 is installed so as to surround a circumference of the permanent magnet 414 as the movable plate 411a is seen in plan view.

In addition, the light scanner 41 includes a voltage applying unit 416 which applies a voltage to the coil 415. The voltage applying unit 416 is configured so as to adjust (change) conditions such as a voltage value, a frequency, or the like of the applied voltage . A driving unit (driving unit) 417 which rotates the movable plate 411a is configured with the voltage applying unit 416, the coil 415, and the permanent magnet 414. A predetermined voltage is applied from the voltage applying unit 416 to the coil 415, so that a predetermined current is flowed.

For example, if an alternating voltage is applied from the voltage applying unit 416 to the coil 415, a current is flowed in response thereto, so that a magnetic field is generated in the thickness direction (up-down direction in FIG. 5A and 5B) of the movable plate 411a, and the direction of the magnetic field is periodically switched. In other words, a state A where a near portion of the upper side of the coil 415 becomes the S pole and a near portion of the lower side thereof becomes the N pole and a state B where the near portion of the upper side of the coil 415 becomes the N pole and the near portion of the lower side thereof becomes the S pole are alternately switched over each other. At this time, the voltage applying unit 416 is controlled to be driven by a later-described operation control unit 5.

In the state A, as illustrated in FIG. 5A, the right side portion of the permanent magnet 414 is shifted upward by a repulsive force with respect to the magnetic field generated through current conduction of the coil 415, and the left side portion of the permanent magnet 414 is shifted downward by an attractive force with respect to the magnetic field. By doing so, the movable plate 411a rotates counterclockwise to be inclined. On the other hand, in the state B, as illustrated in FIG. 5B, the right side portion of the permanent magnet 414 is shifted downward, and the left side portion of the permanent magnet 414 is shifted upward. By doing so, the movable plate 411a rotates clockwise to be inclined.

By alternately repeating the state A and the state B, the connection portions 411c and 411d are torsion-deformed, and the movable plate 411a is allowed to rotate (vibrate) around the rotation central axis J1.

In addition, under the control of the operation control unit 5 described later, it is possible to adjust a flowing current by adjusting a voltage applied from the voltage applying unit 416 to the coil 415. By doing so, it is possible to adjust the deflection angle (amplitude) of the rotation of the movable plate 411a (the reflection surface of the light reflector 411e) around the rotation central axis J1.

Furthermore, if the movable plate 411a can be allowed to rotate, the configuration of the light scanner 41 is not particularly limited. For example, the light scanner 41 may include a two-degree-of-freedom vibration system. In addition, as the method of driving the light scanner 41, for example, piezoelectric driving using a piezoelectric device, electrostatic driving using an electrostatic attractive force, or the like may be used instead of the electromagnetic driving using the coil 415 and the permanent magnet 414.

As illustrated in FIG. 3, in the above-described configuration, the light scanners 41 and 42 are installed so that the directions of the rotation central axes J1 and J2 are perpendicular to each other. The light scanners 41 and 42 are installed in such a configuration, so that it is possible to two-dimensionally (in two perpendicular directions) scan the laser beam LL emitted from the light source unit 3 on the display surface 91. By doing so, it is possible to render a two-dimensional image on the display surface 91 by using a relatively simple configuration.

More specifically, the light emitted from the light source unit 3 is reflected on the reflection surface of the light reflector 411e of the light scanner 41, and after that, the reflected light is reflected on the reflection surface of the light reflector 421e of the light scanner 42 to be projected (illuminated) on the display surface 91. At this time, the light reflector 411e of the light scanner 41 is allowed to rotate, and the light reflector 421e of the light scanner 42 is allowed to rotate at an angular velocity lower than an angular velocity (speed) of the light reflector 411e. By doing so, the laser beam LL emitted from the light source unit 3 is scanned on the display surface 91 in the horizontal direction and is scanned in the vertical direction at a scanning speed lower than the horizontal scanning speed. In this manner, the laser beam LL emitted from the light source unit 3 is two-dimensionally scanned on the display surface 91, so that an image is rendered on the display surface 91.

Herein, since the light reflector 421e of the light scanner 42 is allowed to rotate at the angular velocity lower than the angular velocity of the light reflector 411e of the light scanner 41, for example, it may be configured so that the light scanner 41 is resonance-driven using resonance and the light scanner 42 is non-resonance-driven using no resonance. In addition, in the case where the light scanners 41 and 42 are resonance-driven at the same time, the light scanners 41 and 42 may be designed so that the resonance frequency of the light scanner 41 (resonance frequency of a vibration system including the movable plate 411a and the connection portions 411c and 411d) is higher than the resonance frequency of the light scanner 42.

Furthermore, it may be configured so that the light beam emitted from the light source unit 3 is first reflected by the light reflector 421e of the light scanner 42 and, after that, the light beams is reflected by the light reflector 411e of the light scanner 41. In other words, it may be configured so that the vertical scanning is first performed, and after that, the horizontal scanning is performed.

Next, an angle detecting unit 43 which detects an angle of the movable plate 411a of the light scanner 41 will be described. Furthermore, since an angle detecting unit 44 which detects an angle of the movable plate 421a of the light scanner 42 has the same configuration as that of the angle detecting unit 43, the description thereof is omitted.

As illustrated in FIG. 4, the angle detecting unit 43 includes a piezoelectric device 431 installed on the connection portion 411c of the light scanner 41, an electromotive force detector 432 which detects an electromotive force generated from the piezoelectric device 431, and an angle sensor 433 which obtains the angle of the movable plate 411a (senses the behavior) based on a result of the detection of the electromotive force detector 432.

If the connection portion 411c is torsion-deformed according to the rotation of the movable plate 411a, the piezoelectric device 431 is deformed according to the deformation. If the piezoelectric device 431 is deformed from a natural state where no external force is exerted, since the piezoelectric device 431 has a property of generating an electromotive force having a magnitude according to an amount of the deformation (in other words, a property where a resistance value is changed according to the amount of the deformation) , the angle sensor 433 obtains a degree of torsion of the connection portion 411c based on a magnitude of the electromotive force (or resistance value) detected by the electromotive force detector 432 and obtains the angle of the movable plate 411a (the reflection surface of the light reflector 411e) from the degree of torsion. In addition, the angle sensor 433 obtains a deflection angle (maximum deflection angle) of the movable plate 411a with respect to the rotation central axis J1 as a center. A signal including information on the angle and the deflection angle of the movable plate 411a is transmitted from the angle sensor 433 to the operation control unit 5.

Furthermore, the detection reference (0°) of the angle of the movable plate 411a may be set although the light scanner 41 is in any state. For example, the detection reference may be set when the light scanner 41 is set to be in the initial state (the state where a voltage is not applied to the coil 415). In addition, the detection of the angle of the movable plate 411a may be performed in real time (continuously) or intermittently. In addition, with respect to the angle detecting unit 43, if the angle of the movable plate 411a can be detected, it is not limited to an angle detecting unit using a piezoelectric device like the embodiment, and for example, an optical sensor may be employed.

### Operation Control Unit

Next, the operation control unit 5 will be described.

As illustrated in FIG. 6, the operation control unit 5 includes a video data storage unit (video data storage unit) 51 which stores video data (image data) used at the time of rendering an image, a video data calculating unit 52, an image rendering timing generator 53, alight source modulator (light modulating unit) 54, and a deflection angle calculating unit (amplitude calculating unit) 55, and an angle indicating unit 56. Particularly, the operation control unit 5 constitutes a changing unit (amplitude changing unit) which changes the amplitude (deflection angle) of the rotation of the light reflector 411e of the movable plate 411a which performs scanning in the horizontal direction (first direction). The operation control unit 5 changes a horizontal length of an image renderable region 912 as a region where rendering can be performed by changing the amplitude (deflection angle) of the rotation of the light reflector 411e.

In other words, the operation control unit 5 changes the amplitude of the rotation of the light reflector 411e, so that a first state where a first region 912a of the display surface 91 is scanned with light as illustrated in FIG. 7A and a second state where the first region 912a of the display surface 91 and second regions 912b and 912c differently adjacent to the first region 912a are scanned with light as illustrated in FIG. 7B are switched over each other.

By doing so, it is possible to suppress the amplitude of the rotation of the light reflector 411e so that the image renderable region 912 is enlarged only in the necessary case and the image renderable region 912 reaches the minimum limit if necessary in the other cases. Therefore, in comparison with the case where the amplitude of the rotation of the light reflector 411e is constant, it is possible to suppress power consumption.

Hereinafter, the operation control unit 5 will be described in detail.

In the control of the projector 2 performed by the operation control unit 5, first, video data are input to the projector 2. The input video data are temporarily stored in the video data storage unit 51, and the image rendering is performed by using the video data read from the video data storage unit 51. In this case, after all the video data are stored in the video data storage unit 51, the image rendering may be configured to start, or after a portion of the video data is stored in the video data storage unit 51, the image rendering may be configured to start and the continued video data may be configured to be stored in the video data storage unit 51 in parallel to the image rendering.

In the case where the image rendering starts after a portion of the video data is stored in the video data storage unit 51, the video data of at least one frame is first stored in the video data storage unit 51, and after that, the image rendering starts.

The image rendering timing generator 53 generates image rendering timing information and image rendering line information. The image rendering timing information is transmitted to the video data calculating unit 52, and the image rendering line information is transmitted to the deflection angle calculating unit 55 and the angle indicating unit 56.

The image rendering timing information includes information on timing (light emitting timing of each pixel) of performing rendering, information on intensity (intensity of light per area of a display surface) of light of each pixel, and the like. In addition, the image rendering line information includes information on a vertical position (target angle of the movable plate 421a) of an image rendering line L where the rendering is performed as illustrated in FIGS. 8A and 8B, information on a length (target angle of the movable plate 411a) of the image rendering line L, and the like. Furthermore, although a position of a portion of the image rendering line L may be set as the vertical position of the image rendering line L, for example, a left-side distal end, a right-side distal end, a center, or the like may be set.

In addition, as described later, the image rendering line information is changed based on the video data. In addition, the image rendering timing information is changed according to the change of the image rendering line information.

The video data calculating unit 52 reads video data corresponding to to-be-rendered pixels from the video data storage unit 51 based on the image rendering timing information input from the image rendering timing generator 53 and performs various corrections and calculations, and after that, transmits brightness data of each color to the light source modulator 54.

The light source modulator 54 modulates the light sources 320r, 320g, and 320b through the driving circuits 310r, 310g, and 310b based on brightness data of each color input from the video data calculating unit 52. In other words, turning-on/off of each of the light sources 320r, 320g, and 320b, output adjusting (increasing/decreasing), and the like are performed. By doing so, the light source unit 3 sequentially emits light corresponding to each pixel of the video data (image information) with predetermined timing and intensity.

The angle detecting unit 43 in the light scanner 41 detects an angle and a deflection angle of the movable plate 411a and transmits information on the angle and deflection angle (angle information of the movable plate 411a) to the image rendering timing generator 53 and the deflection angle calculating unit 55 of the operation control unit 5. In addition, the angle detecting unit 44 in the light scanner 42 detects an angle of the movable plate 421a and transmits information on the angle (angle information of the movable plate 421a) to the angle indicating unit 56 of the operation control unit 5.

If the rendering of the current image rendering line L ends and the information on the deflection angle of the movable plate 411a is input from the angle detecting unit 43, the image rendering timing generator 53 transmits target angle information (angle indication) indicating the target angle of the movable plate 421a of the time of illumination of the laser beam LL to the angle indicating unit 56 at the rendering start point of the image rendering line L where the next rendering is to be performed, in synchronization with the inputting. The target angle of the movable plate 421a is set so that a pitch of the image rendering lines L is constant. The angle indicating unit 56 compares the angle of the movable plate 421a detected by the angle detecting unit 44 with the target angle of the movable plate 421a, performs correction so that the difference becomes zero, and transmits driving data to a driving unit 427 of the light scanner 42.

The driving unit 427 drives the light scanner 42 (applies a voltage to the coil) based on the driving data. By doing so, when the laser beam LL is illuminated at the image rendering start point, the angle of the movable plate 421a becomes the target angle.

Furthermore, in the embodiment, in each of the image rendering lines L, from the image rendering start point to the image rendering end point, the angular velocity of the movable plate 421a is maintained constant, and the speed of scanning the laser beam LL in the vertical direction is maintained constant. However, it may be configured so that the angular velocity of the movable plate 421a is gradually changed and the speed of scanning the laser beam LL in the vertical direction is gradually changed.

In addition, the image rendering timing generator 53 transmits the image rendering line information, that is, information on a vertical position of the image rendering line L where the next rendering is to be performed and information of a length of the image rendering line L to the deflection angle calculating unit 55.

The deflection angle calculating unit 55 obtains a target deflection angle (target value of the deflection angle) of the movable plate 411a in the image rendering line L where the next rendering is to be performed based on the information on the vertical position of the image rendering line L where the next rendering is to be performed and the information on the length of the image rendering line L input from the image rendering timing generator 53.

Next, driving data are transmitted to a driving unit 417 of the light scanner 41 based on the information on the deflection angle of the movable plate 411a input from the angle detecting unit 43 and the target deflection angle of the movable plate 411a so that the deflection angle of the movable plate 411a becomes the target deflection angle.

The driving unit 417 applies an effective voltage having a frequency equal to a resonance frequency of the light scanner 41 to the coil 415 based on the driving data to allow a current to flow through the coil 415 to generate a predetermined magnetic field and changes a magnitude of an effective current or a phase difference between the light scanner 41 and a driving waveform to supply energy to the light scanner 41 or conversely take away energy from the light scanner 41. By doing so, the deflection angle of the movable plate 411a which is in a resonant motion becomes the target deflection angle. In this manner, the image rendering is performed by sequentially scanning the laser beam LL on the image rendering lines L of the image rendering region 911 while adjusting the deflection angle of the movable plate 411a based on information (result of the detection) on the deflection angle of the movable plate 411a detected by the angle detecting unit 43 and the target deflection angle (target value) so that the deflection angle of the movable plate 411a becomes the target deflection angle. In this manner, the operation control unit 5 changes the deflection angle of the light reflector 411e, which performs scanning in the horizontal direction, by adjusting a magnitude of a current or a voltage generated by a the voltage applying unit 416 of the driving unit 417. By doing this, it is possible to simply and securely change the deflection angle of the light reflector 411e. Furthermore, the operation control unit 5 may also change the deflection angle of the light reflector 411e, which performs scanning in the horizontal direction, by adjusting a magnitude and frequency of a current or a voltage generated by the voltage applying unit 416 of the driving unit 417.

In addition, the operation control unit 5 controls operations of the projector 2 based on information from the information providing unit 7. For example, the operation control unit 5 may change the image which the projector 2 displays or the deflection angle (amplitude of the rotation) of the light reflector 411e based on information from the information providing unit 7.

### Information Providing Unit

As illustrated in FIG. 3, the information providing unit 7 includes an external sensor 71 and a navigation apparatus 72. The external sensor 71 is, for example, an image sensor such as a CCD image sensor and a CMOS image sensor. In addition, the external sensor 71 may be a sensor capable of sensing presence and absence of an object by using a non-optical method such as an infrared sensor and an ultrasonic sensor. The external sensor 71 is attached to the moving body M and has a function of, for example, sensing the presence or absence of signs (road traffic signs) or moving bodies such as persons, bicycles, or other cars in front of the moving body M in the moving direction thereof, as a situation of the surroundings of the moving body M. In addition, the external sensor 71 may also have a function of determining a position, a progressing direction, or a progressing speed of the sensed moving body or a content of the sensed sign. Herein, the external sensor 71 constitutes a situation sensor (situation sensing unit) which senses the situation of the surroundings of the moving body M.

The navigation apparatus 72 has a function of guiding a manipulator through a path to a destination by using GPS. In the display apparatus 1 having the above configuration, as described above, the operation control unit 5 changes the amplitude of the rotation of the light reflector 411e. By doing so, a first state (hereinafter, simply referred to as a “first state”) where the first region 912a of the display surface 91 is scanned with light as illustrated in FIG. 8A and a second state (hereinafter, simply referred to as a “second state”) where the first region 912a of the display surface 91 and the second regions 912b and 912c differently adjacent to the first region 912a are scanned with light as illustrated in FIG. 8B are switched over each other.

By doing so, it is possible to suppress the amplitude of the rotation of the light reflector 411e so that the image renderable region 912 is enlarged only in the necessary case and the image renderable region 912 reaches the minimum limit if necessary in the other cases. Therefore, in comparison with the case where the amplitude of the rotation of the light reflector 411e is constant, it is possible to suppress power consumption.

More specifically, as illustrated in FIGS. 8A and 8B, a plurality of the image rendering lines (scan lines) L are disposed in a zigzag shape as a trajectory of the laser beam LL on the display surface 91.

Herein, the light scanning unit 4 forms one frame image on the display surface 91 by performing horizontal scanning several times during one vertical scanning and sequentially forms plural frame images on the display surface 91 by repetitively performing the one-frame image forming operation.

The lengths of the plurality of the image rendering lines L become the same in each frame. In other words, in each frame, a light emitting state where the laser beam LL is emitted from the light source unit 3 (hereinafter, simply referred to as a “light emitting state”) and a horizontal deflection width of the laser beam LL on the display surface 91 (hereinafter, simply referred to as a “deflection width of the laser beam (light) LL”) become constant.

The length of the image rendering line L may be changed by changing the deflection angle of the movable plate 411a with respect to the rotation central axis J1 as a center (hereinafter, simply referred to as a “deflection angle of the movable plate 411a”).

Therefore, the operation control unit 5 changes the horizontal length of the image renderable region 912 by changing the deflection angle of the movable plate 411a, that is, the deflection angle (amplitude of the rotation) of the light reflector 411e of the movable plate 411a.

More specifically, the operation control unit 5 allows the deflection angle θ₁ of the light reflector 411e in the first state to be an angle θ₁₁ and allows the deflection angle θ₁ of the light reflector 411e in the second state to be an angle θ₁₂ larger than the angle θ₁₁.

In the first state, for example, as illustrated in FIG. 8A, the length of the image rendering line L is set to be relatively small. By doing so, the area of the image renderable region 912 formed on the display surface 91 becomes relatively small. Herein, in the first state, the image renderable region 912 is configured to include the first region 912a. In addition, a length of the image rendering line L, that is, a horizontal deflection width Al of the light beam LL is configured to be slightly longer (B1+α) than a horizontal length B1 of the first region 912a.

As described above, although the horizontal scanning is performed several times in each frame, as illustrated in FIG. 10, in the horizontal scanning in the first state, the deflection angle θ₁ of the movable plate 411a becomes constant (angle θ₁₁). Furthermore, herein, the “deflection angle θ₁ of the movable plate 411a” denotes an angle (maximum deflection angle) between the movable plate 411a at the time when the movable plate 411a rotates up to the maximum angle (θ₁/2) clockwise (in the one direction) in FIGS. 5A and 5B and the movable plate 411a at the time when the movable plate 411a rotates up to the maximum angle (θ₁/2) counterclockwise (in the other direction) in FIGS. 5A and 5B (that is the same in FIG. 11).

Furthermore, in the embodiment, the deflection angle θ₁ of the movable plate 411a in the display period of each frame is constant. However, in the case where keystone correction is necessary, the deflection angle may be allowed to be changed so as to be gradually increased or decreased.

In addition, as described above, although the vertical scanning is performed once in each frame, in the first and second states, a deflection angle θ₂ (maximum deflection angle) of the movable plate 421a is a constant angle (angle θ₂₁). More specifically, as illustrated in FIG. 9, in one frame, the angle θ₂ of the movable plate 421a is gradually increased from the minimum deflection angle in the display period where the image display is performed, and after the angle reaches the maximum deflection angle, the angle is rapidly decreased. Next, similarly, in each of the following frames, the above operation is repetitively performed. Furthermore, FIG. 9 illustrates a change of the rotation angle of the movable plate 421a between the time when the movable plate 421a rotates up to the maximum angle (minimum deflection angle) in the one direction and the time when the movable plate 421a rotates up to the maximum angle (maximum deflection angle) in the other direction in each frame.

In addition, a period when the deflection angle θ₂ of the movable plate 421a is rapidly decreased as described above is referred to as a “vertical flyback period”. The vertical flyback period is set in the vicinity thereof between two adjacent frames. On the other hand, in the second state, for example, as illustrated in FIG. 8B, a length of the image rendering line L is set to be larger than that of the image rendering line L in the first state. By doing so, the area of the image renderable region 912 formed on the display surface 91 is larger than that of the image renderable region 912 in the first state. Herein, the image renderable region 912 in the second state is configured to include the first region 912a, the second region 912b adjacent to the one horizontal side (left side in FIG. 8B) of the first region 912a, and the second region 912c adjacent to the other horizontal side (right side in FIG. 8B) of the first region 912a. In addition, the length of the image rendering line L, that is, the horizontal deflection width Al of the light beam LL is configured to be slightly longer (B1+B2+B3+α) than a sum of the horizontal length B1 of the first region 912a, the horizontal length B2 of the second region 912b, and the horizontal length B3 of the second region 912c. In this manner, the first state where the image renderable region 912 is configured to include only the first region 912a and the second state where the image renderable region 912 is configured to include the first region 912a and the second regions 912b and 912c are switched over each other.

In the first state, as illustrated in FIG. 7A, an image g1 is displayed in the first region 912a.

In the second state, as illustrated in FIG. 7B, the image g1 is displayed in the first region 912a; an image g2 is displayed in the second region 912b; and an image g3 is displayed in the second region 912c. Furthermore, in the second state, at least one of the image g2 and the image g3 maybe displayed if necessary, and no image may be displayed in any one of the second region 912b and the second region 912c.

In addition, the image g1 displayed in the first region 912a in the first state and the image g1 displayed in the first region 912a in the second state are the same in type, and the image g1 displayed in the first region 912a and the images displayed in the second regions 912b and 912c are different from each other in type. Herein, the displayed images that are the same in type include images of the same index or images on information that can be grouped in the same concept. For example, in the case where images commonly represent speeds, although the displayed numerical values are different, the image may be considered to be the same in type. Besides the speed, an engine rpm, a remaining fuel level, or the like are similar. In addition, if information (warning lights for water temperature, oil temperature, or the like) of various meters is included in the concept that it is information of various meters, although there is a difference in display contents, the information may be considered to be the same in type. By doing so, the images g2 and g3 which are not displayed in the first state are displayed as different images in a region different from the region where the image g1 is displayed in the second state. Therefore, in the second state, it is possible to easily highlight the images g2 and g3 in comparison with the image g1.

In addition, the image g1 includes an image representing information on a moving state of the moving body M, and in the second regions 912b and 912c, the images g2 and g3 include an image representing information on an external situation of the surroundings of the moving body M. By doing so, in the first and second states, it is possible to provide the information on the moving state of the moving body M, and in the second state, it is possible to notify the information on the external situation of the surroundings of the moving body M.

In the embodiment, as illustrated in FIG. 7, an image representing information on a speed of the moving body M is used as an image included in the image g1. Furthermore, with respect to the image g1, if an image includes an image representing the information on the moving state of the moving body M, the invention is not limited thereto. Besides, for example, an image representing information on various meters such as an engine rpm, a remaining fuel level, a water temperature, and an oil temperature may be used.

In addition, as an image included in the image g2, an image representing navigation information is used, and as an image included in the image g3, an image representing caution information is used. Furthermore, with respect to the images g2 and g3, if an image includes an image representing the information on the external situation of the surroundings of the moving body M, the invention is not limited thereto.

In addition, the aforementioned switching of the first state and the second state is performed according to the information from the aforementioned information providing unit 7 (more specifically, the external sensor 71 or the navigation apparatus 72). In other words, the operation control unit 5 switches the first state and the second state based on a result of the sensing of the external sensor 71 or guide information of the navigation apparatus 72. In this manner, the first state and the second state are switched over each other based on the result of the sensing of the external sensor 71, so that it is possible to sense the situation of the surroundings of the moving body M and to notify the result of the sensing.

For, example, in general, the first state is maintained, and when a person is dashing out to the front fo the moving body M, the external sensor 71 senses the person, and based on a result of the sensing, the first state is switched over to the second state. Next, the indication denoting that a person is dashing out, for example, a pictogram, characters, an image captured by the external sensor 71, or the like is displayed in the second region 912c.

In addition, when guidance of the navigation apparatus 72 is necessary, the first state is switched over to the second state, and an image regarding to guidance information of the navigation apparatus 72 is displayed in the second region 912b. Particularly, the operation control unit 5 constitutes an adjusting unit (light emitting control unit) which adjusts at least one of a resolution of an image displayed on the display surface 91 and brightness of each pixel. More specifically, the adjusting unit has a function of adjusting a light emitting timing of the light emitted from the light emitting unit 3 and an amount of light emitting from the light emitting unit 3. Therefore, due to the adjusting of the adjusting unit, it is possible to display the image g1 of which the visibility is the same in the first and second states (image of which the size, brightness, or resolution (feeling of resolution), is the same) in the first region 912a. For this reason, although the area of the image renderable region 912 changes, it is possible to reduce the change in outer appearance of the image g1 displayed in the first region 912a, so that it is possible to display an image which provokes a viewing person to less discomfort and is easily seen by the viewing person.

In the embodiment, when the same image g1 is displayed in the first region 912a in the first and second states, the operation control unit 5 allows the amount of light per unit area emitted from the light emitting unit 3 to the first region 912a in the first state and the amount of light per unit area emitted from the light emitting unit 3 to the first region 912a in the second state to be equalized by adjusting the amount of light emitted from the light emitting unit 3. In other words, the operation control unit 5 allows the brightness of each pixel corresponding to the image g1 in the first state and the brightness of each pixel corresponding to the image g1 in the second state to be equalized. By doing so, when the image g1 is displayed in the first state and the second state, it is possible to prevent the brightness of the image g1 from being changed at the time of switching between the first state and the second state. Therefore, it is possible to display the image g1 in such a manner that the image is seen to be substantially the same in both of the first and second states, and it is possible to perform display which is easily seen by a viewing person.

In addition, the operation control unit 5 allows the resolution of the image g1 displayed in the first region 912a in the first state and the resolution of the image g1 displayed in the first region 912a in the second state to be equalized. In the embodiment, the resolution of the image g1 displayed in the first region 912a in the first state and the resolution of the image g1 displayed in the first region 912a in the second state are denoted by X[dpi]. By doing so, it is possible to reduce a change in the resolution of the image g1 displayed in the first region at the time of switching between the first state and the second state. As a result, it is possible to allow a viewing person not to easily recognize a change in a feeling of resolution of the image; and it is possible to reduce discomfort in outer appearance, so that it is possible to perform display which is easily seen by the viewing person. In addition, it is possible to relatively simply prevent the brightness of the image g1 from being changed at the time of switching between the first state and the second state.

In addition, the resolution of the image g1 and the resolution of the images g2 and g3 are allowed to be equal to each other in the second state. By doing so, it is possible to allow a viewing person not to easily recognize a difference in a feeling of resolution among the images g1, g2, and g3 in the second state, so that it is possible to perform display which is easily seen by the viewing person.

In the display apparatus 1 according to the first embodiment described hereinbefore, it is possible to suppress the amplitude of the rotation of the light reflector 411e so that the image renderable region 912 is enlarged only in the case where external information or the like of the moving body M is to be displayed and the image renderable region 912 reaches the minimum limit if necessary in the other cases. Therefore, in comparison with the case where the amplitude of the rotation of the light reflector 411e is constant, it is possible to suppress power consumption.

In addition, although the horizontal length of the image renderable region 912 is changed, it is possible to display the same image with the same brightness before and after the change (that is, between the first state and the second state). Therefore, it is possible to perform display which provokes a viewing person to less discomfort and is easily seen by the viewing person.

### Second Embodiment

Next, a display apparatus according to a second embodiment of the invention will be described.

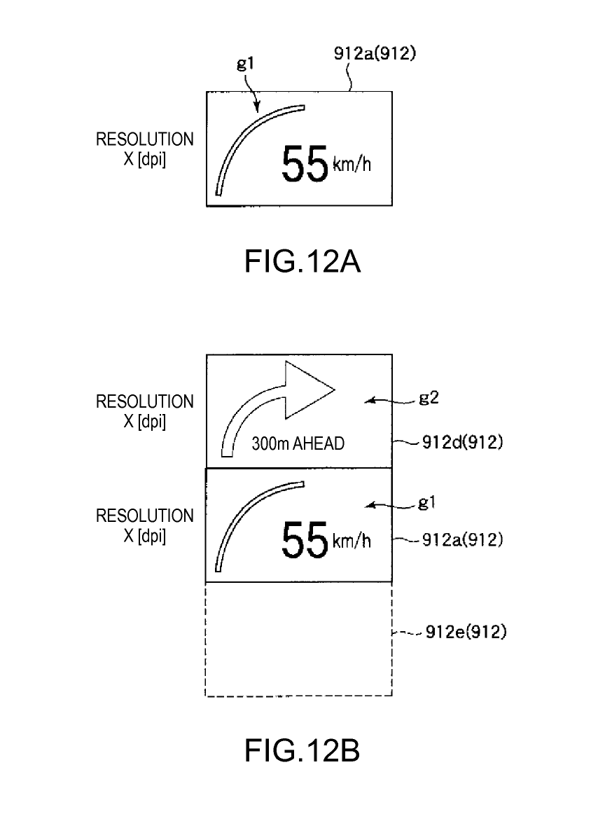

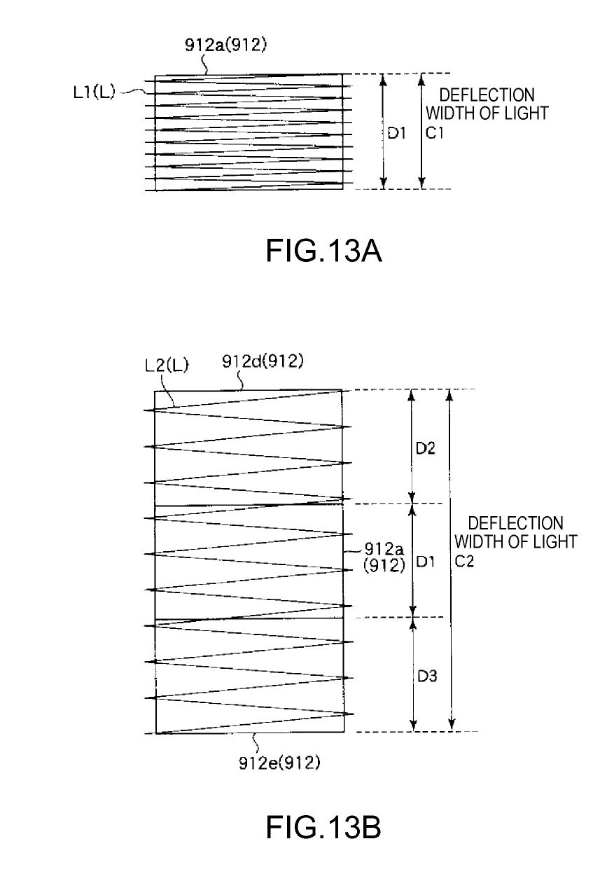

FIGS. 12A and 12B are diagrams illustrating operations of the display apparatus according to the second embodiment of the invention (diagrams illustrating an image renderable region, an image rendering region, and an image). FIGS. 13A and 13B are diagrams illustrating the image renderable region illustrated in FIGS. 12A and 12B.

Hereinafter, the display apparatus according to the second embodiment will be described concentrating on differences from the aforementioned first embodiment, and description of the same configurations will be omitted.

The display apparatus according to the second embodiment is substantially the same as the display apparatus according to the first embodiment except that the horizontal length of the image renderable region is not changed and the vertical length of the image renderable region is changed. Furthermore, in FIGS. 12A, 12B, 13A, and 13B, the same configurations as the aforementioned embodiment are denoted by the same reference numerals.

In the embodiment, a vertical length of the image renderable region 912 as a region where rendering can be performed is changed by changing the amplitude (deflection angle) of the rotation of the light reflector 421e of the light scanner 42 for vertical scanning.

In other words, the amplitude of the rotation of the light reflector 421e is changed, so that a first state where the first region 912a of the display surface 91 is scanned with light as illustrated in FIG. 13A and a second state where the first region 912a of the display surface 91 and the second regions 912d and 912e adjacent to the first region 912a are scanned with light as illustrated in FIG. 13B are switched over each other.

By doing so, it is possible to suppress the amplitude of the rotation of the light reflector 421e so that the image renderable region 912 is enlarged only in the case where external information or the like of the moving body M is to be displayed and the image renderable region 912 reaches the minimum limit if necessary in the other cases. Therefore, in comparison with the case where the amplitude of the rotation of the light reflector 421e is constant, it is possible to suppress power consumption.

Herein, in the first state, a vertical deflection width C1 of the light beam LL is configured to be substantially equal to a vertical length D1 of the first region 912a.

Herein, the image renderable region 912 in the second state includes a first region 912a, a second region 912d adjacent to the one vertical side (upper side in FIG. 13B) of the first region 912a, and a second region 912e adjacent to the other vertical side (lower side in FIG. 13B) of the first region 912a.

In addition, a vertical deflection width C2 of the light beam LL is configured to be substantially equal to a sum of the vertical length D1 of the first region 912a, the vertical length D2 of the second region 912d, and the vertical length D3 of the second region 912e.

In the first state, as illustrated in FIG. 12A, the image g1 is displayed in the first region 912a.

In the second state, as illustrated in FIG. 12B, the image g1 is displayed in the first region 912a, and the image g2 is displayed in the second region 912d. In the embodiment, in the second state, no image is also displayed in the second region 912e. Furthermore, in the second state, an image may be displayed in the second region 912e. In addition, in the second state, the image g2 and the image g3 (refer to FIG. 7B) may be selectively displayed in the second region 912d.

In this manner, the image g2 is displayed in the upper side of the image g1, so that in the second state, it is possible to highlight the image g2 in comparison with the image g1. In addition, the resolution of the image g1 displayed in the first region 912a in the first state and the resolution of the image g1 displayed in the first region 912a in the second state are allowed to be equal to each other. By doing so, it is possible to reduce a change in the resolution of the image g1 displayed in the first region at the time of switching between the first state and the second state. As a result, it is possible to allow a viewing person not to easily recognize a change in a feeling of resolution of the image; and it is possible to reduce discomfort in outer appearance, so that it is possible to perform display which is easily seen by the viewing person. In addition, it is possible to relatively simply prevent the brightness of the image g1 from being changed at the time of switching between the first state and the second state. At this time, in the embodiment, since the frequency of the horizontal scanning and the frequency of the vertical scanning are not changed, for example, the intensity of light emitted from the light emitting unit 3 at the time of scanning of the first region 912a in the second state is configured to larger than the intensity of light emitted from the light emitting unit 3 at the time of scanning of the first region 912a in the first state. In addition, in the case where the intensity of light emitted from the light emitting unit 3 at the time of scanning of the first region 912a in the second state and the intensity of light emitted from the light emitting unit 3 at the time of scanning of the first region 912a in the first state are configured to be equal to each other, the frequency of the vertical scanning in the second state may be configured to be higher than the frequency of the vertical scanning in the first state.

In the display apparatus according to the second embodiment described hereinbefore, it is possible to obtain the same effects as those of the aforementioned first embodiment.

### Third Embodiment

Next, a display apparatus according to a third embodiment of the invention will be described.

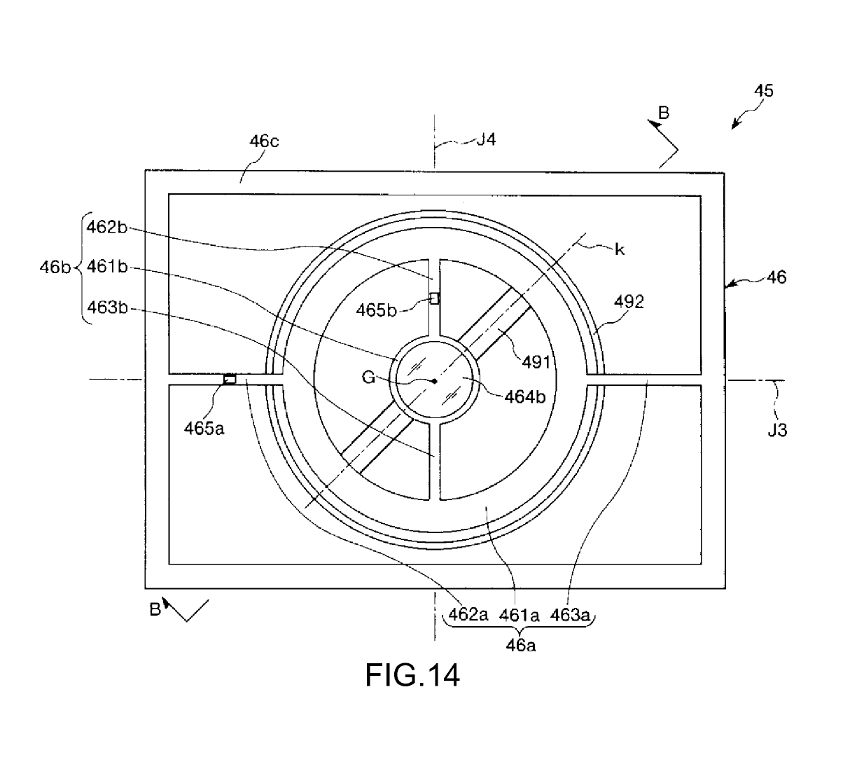

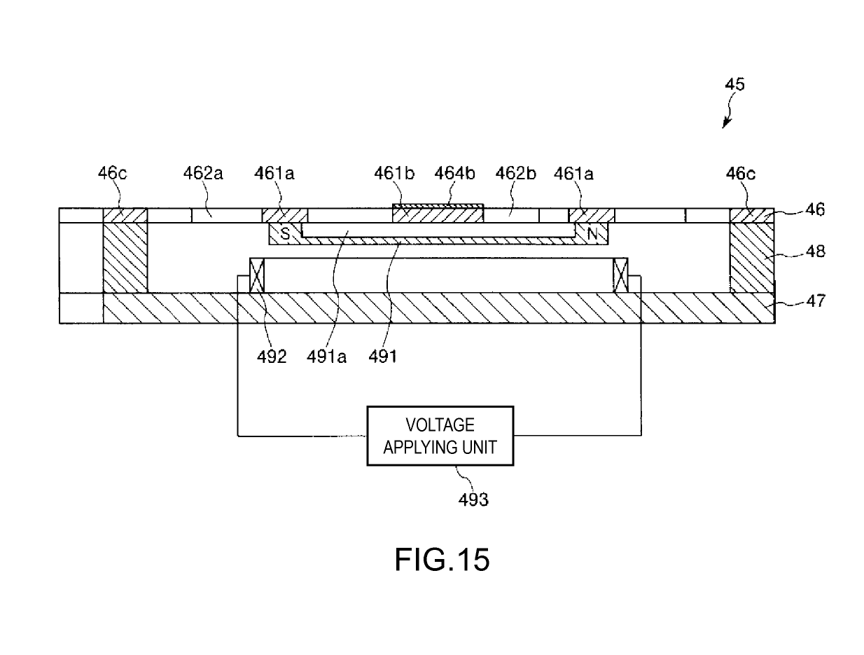

FIG. 14 is a schematic plan diagram illustrating a light scanner of a projector included in a display apparatus according to the third embodiment of the invention. FIG. 15 is a cross-sectional diagram taken along line XV-XV of FIG. 14. In addition, hereinafter, for the convenience of description, the paper-surface front, paper-surface rear, right, and left sides of FIG. 14 are referred to as “upper”, “lower”, “right”, and “left”, respectively; and the upper, lower, right, and left sides of FIG. 15 are referred to as “upper”, “lower”, “right”, and “left”, respectively.

Hereinafter, the display apparatus according to the third embodiment will be described concentrating on differences from the aforementioned first embodiment, and description of the same configurations will be omitted.

The display apparatus according to the third embodiment is substantially the same as the display apparatus according to the first embodiment except for configurations of a light scanner included in a projector.

The light scanning unit according to the embodiment includes one light scanner 45 of a so-called two-degree-of-freedom vibration system (two-dimensional scanning).

As illustrated in FIG. 14, the light scanner 45 includes a substrate 46 including a first vibration system 46a, a second vibration system 46b, and a supporting portion 46c, an opposite substrate 47 disposed to face the substrate 46, a spacer member installed between the substrate 46 and the opposite substrate 47, a permanent magnet 491, and a coil 492.

The first vibration system 46a is configured to include a driving unit 461a having a shape of a frame installed in an inner side of the frame-shaped supporting portion 46c and one pair of first connection portions 462a and 463a which supports the driving unit 461a at both ends of the supporting portion 46c.

The second vibration system 46b is configured to include a movable plate 461b installed in an inner side of the driving unit 461a and one pair of second connection portions 462b and 463b which supports the movable plate 461b at both ends of the driving unit 461a.

As seen in plan view of FIG. 14, the driving unit 461a has a shape of a ring. Furthermore, if the driving unit 461a has a shape of a frame, the shape is not particularly limited. For example, as seen in plan view of FIG. 14, the driving unit 461a may have a shape of a quadrilateral ring. The permanent magnet 491 is attached to the lower surface of the driving unit 461a. Each of the first connection portions 462a and 463a has a shape of a rectangle and is elastically deformable. Each of the first connection portions 462a and 463a connects the driving unit 461a and the supporting portion 46c so that the driving unit 461a is rotatable with respect to the supporting portion 46c. The first connection portions 462a and 463a are installed so as to be concentric with each other, and it is configured so that the driving unit 461a is allowed to rotate around the axis (hereinafter, referred to as a “rotation central axis J3”) with respect to the supporting portion 46c.

A piezoelectric device 465a for detecting the angle (rotation angle around the rotation central axis J3) (behavior) of the driving unit 461a is installed in the first connection portion 462a.

As seen in plan view of FIG. 14, the movable plate 461b has a shape of a circle. Furthermore, if the movable plate 461b can be formed in an inner side of the driving unit 461a, the shape of the movable plate 461b is not particularly limited. For example, as seen in plan view of FIG. 14, the movable plate 461b may have a shape of an ellipse or a shape of a quadrangle. A light reflector 464b having a light reflection property is formed on an upper surface of the movable plate 461b.

Each of the second connection portions 462b and 463b has a shape of a rectangle and is elastically deformable. Each of the second connection portions 462b and 463b connects the movable plate 461b and the driving unit 461a so that the movable plate 461b is rotatable with respect to the driving unit 461a. The second connection portions 462b and 463b are installed so as to be concentric with each other, and it is configured so that the movable plate 461b is allowed to rotate around the axis (hereinafter, referred to as a “rotation central axis J4”) with respect to the driving unit 461a.

A piezoelectric device 465b for detecting the angle (rotation angle around the rotation central axis J4) (behavior) of the movable plate 461b is installed in the second connection portion 462b.

As illustrated in FIG. 14, the rotation central axis J3 and the rotation central axis J4 are perpendicular to each other. In addition, as seen in plan view of FIG. 14, the center of the driving unit 461a and the center of the movable plate 461b are located at the intersection of the rotation central axis J3 and the rotation central axis J4. Furthermore, hereinafter, for the convenience of description, the intersection of the rotation central axis J3 and the rotation central axis J4 is referred to as an “intersection G”.

As illustrated in FIG. 15, the substrate 46 having the configuration described hereinbefore is attached to the opposite substrate 47 through the spacer member 48. The coil 492 which generates a magnetic field which is to be exerted on the permanent magnet 491 is installed on an upper surface of the opposite substrate 47.

As seen in plan view of FIG. 14, the permanent magnet 491 is installed along a line segment (referred to as a “line segment k”) which passes through the intersection G and is inclined with respect to each axis of the rotation central axis J3 and the rotation central axis J4. The one longitudinal side of the permanent magnet 491 with respect to the intersection G becomes the S pole, and the other longitudinal side thereof becomes the N pole. In FIG. 15, the left longitudinal side of the permanent magnet 491 becomes the S pole, and the right longitudinal side thereof becomes the N pole.

As seen in plan view of FIG. 14, an inclined angle θ of the line segment k with respect to the rotation central axis J3 is preferably in a range of 30 to 60 degrees, more preferably, in a range of 40 to 50 degrees, and further more preferably substantially 45 degrees. In this manner, the permanent magnet 491 is installed, so that it is possible to smoothly rotate the movable plate 461b around each of the rotation central axis J3 and the rotation central axis J4. In the embodiment, the line segment k is inclined at about 45 degrees with respect to each of the rotation central axis J3 and the rotation central axis J4.

In addition, as illustrated in FIG. 15, a concave portion 491a is formed on an upper surface of the permanent magnet 491. The concave portion 491a is a recess portion for preventing the permanent magnet 491 and the movable plate 461b from being in contact with each other. The concave portion 491a is formed, so that it is possible to prevent the movable plate 461b from being in contact with the permanent magnet 491 when the movable plate 461b rotates around the rotation central axis J3.

As seen in plan view of FIG. 14, the coil 492 is formed so as to surround the circumference of the driving unit 461a. By doing so, it is possible to securely prevent the driving unit 461a and the coil 492 from being in contact with each other at the time of driving the light scanner 45. As a result, it is possible to relatively shorten the separation distance between the coil 492 and the permanent magnet 491, so that it is possible to efficiently exert the magnetic field generated from the coil 492 on the permanent magnet 491.

The coil 492 is electrically connected to a voltage applying unit 493. If the voltage applying unit 493 applies a voltage to the coil 492, a magnetic field in the direction of an axis perpendicular to each of the rotation central axis J3 and the rotation central axis J4 is generated from the coil 492.

The voltage applying unit 493 generates a first voltage for rotating the movable plate 461b around the rotation central axis J3 and a second voltage for rotating the movable plate 461b around the rotation central axis J4, superposes the first voltage and the second voltage, and applies the superposed voltage to the coil 492.

Therefore, a magnetic field allowing the S pole side of the permanent magnet 491 to be attracted to the coil 492 and allowing the N pole side to be separated from the coil 492 and a magnetic field allowing the S pole side of the permanent magnet 491 to be separated from the coil 492 and allowing the N pole side to be attracted to the coil 492 are alternately switched over each other based on the first voltage. By doing so, the first connection portions 462a and 463a are torsion-deformed, and the driving unit 461a together with the movable plate 461b rotates around the rotation central axis J3 with a frequency of the first voltage.

On the other hand, a magnetic field allowing the S pole side of the permanent magnet 491 to be attracted to the coil 492 and allowing the N pole side to be separated from the coil 492 and a magnetic field allowing the S pole side of the permanent magnet 491 to be separated from the coil 492 and allowing the N pole side to be attracted to the coil 492 are alternately switched over each other based on the second voltage. By doing so, the second connection portions 462b and 463b are torsion-deformed, and the movable plate 461b rotates around the rotation central axis J4 with a frequency of the second voltage.

According to the light scanner 45 described hereinbefore, it is possible to two-dimensionally scan the laser beams (light) by using one actuator, so that it is possible to save the space of the light scanning unit 4. In addition, for example, in the case where one pair of the light scanners is used like the first embodiment, the relative positional relationship of the light scanners needs to be set at a high accuracy. However, in the embodiment, such a highly accurate setting is not necessary, so that it is possible to easily perform the manufacturing.

In the third embodiment, it is possible to obtain the same effects as those of the first embodiment.

Hereinbefore, although the display apparatus according to the invention is described based on the illustrated embodiments, the invention is not limited thereto, and the configuration of the components maybe replaced with arbitrary configurations having the same functions. In addition, other configurations may be arbitrarily added to the invention. In addition, the invention may be a combination of arbitrary two or more configurations (features) of the above-described embodiments. In addition, in the above-described embodiment, although the case where the images of a plurality of the frames are displayed by repeating the image rendering from the upper left side to the lower right side of the image renderable region 912 is described, the image of the plurality of the frames may be displayed by alternately repeating the frame where the image rendering is performed from the upper left side to the lower right side of the image renderable region 912 and the frame where the image rendering is performed from the lower right side to the upper left side of the image renderable region 912. In this case, in the even-numbered frames and the odd-numbered frames, the orders of the video data (pixel data) read from the video data storage unit 51 may be set to be reverse.

In addition, in the embodiment, although the case where the image rendering start position is the upper left side in each frame is described, the invention is not limited thereto. For example, the image rendering start position in each frame may be the upper right side, the lower left side, the lower right side, or the like.

In addition, if necessary, the deflection angle of the movable plate may be adjusted in at least one direction of the vertical and horizontal directions, or the so-called keystone correction may be performed by adjusting modulation of the light emitting unit.

In addition, in the first embodiment, although one pair of the light scanners is used as a light scanning unit, the invention is not limited thereto. For example, the light scanner and a galvanometer mirror may be used. In this case, preferably, the galvanometer mirror is used for the vertical scanning. In addition, in the above-described embodiment, although the case where the display apparatus includes one projector is described, the invention is not limited thereto. The number of the projectors included in the display apparatus may be two or more. In this case, a plurality of the projectors may be operated in synchronization with each other.

In addition, in the embodiment, although the first direction denotes the “horizontal direction” and the second direction denotes the “vertical direction”, the invention is not limited thereto. For example, the first direction may denote the “vertical direction”, and the second direction may denotes the “horizontal direction”.

In addition, in the embodiment, although one laser beam (light) is emitted by combining a red laser beam, a green laser beam, and a blue laser beam by using three dichroic mirrors, dichroic prisms or the like may be used for the combination.

In addition, in the above-described embodiment, although the configuration where the light source unit 3 includes a laser source emitting a red laser beam, a laser source emitting a blue laser beam, and a laser source emitting a green laser beam is described, the invention is not limited thereto. For example, the light source unit 3 may include the laser source emitting the red laser beam, the laser source emitting the blue laser beam, and a laser source emitting a UV laser beam. In this case, a fluorescent substance which generates green fluorescent light at the time of illumination of a UV laser beam is included in the display surface. By doing so, it is possible to display a full color image on the display surface. In addition, in the embodiments described above, although the example where the resolution of the first region in the first state and the resolution of the first region in the second state are equal to each other is described, the resolution of the first region in the first state and the resolution of the first region in the second state may be different from each other. In this case, it is possible to display an image of which the visibility is the same both in the first state and in the second state in the first region by adjusting (increasing or decreasing) the brightness of each pixel of the image displayed in the first region in at least one of the first and second states. For example, in the case where the resolution of the image of the first region in the first state is higher than the resolution of the image of the first region in the second state, the brightness of each pixel of the image of the first region in the second state is configured to be stronger than the brightness of each pixel of the image of the first region in the first state.

In addition, in the above-described embodiment, the case where the moving body is a vehicle (car) is described as an example. However, the invention is not limited thereto. The moving body may be, for example, a train, a flight vehicle, a ship, or the like. As a flight vehicle, for example, an airplane such as a passenger plane and a fighter aircraft, a helicopter, an airship, or the like may be exemplified.

The entire disclosure of Japanese Patent Application No. 2011-128067, filed on Jun. 8, 2011 is expressly incorporated by reference herein.

What is claimed is:

1. A display apparatus comprising:
a light emitting unit which emits light;
a light scanning unit which includes at least one light reflector reflecting light emitted from the light emitting unit and being swingably installed around a swing axis, scans the light reflected by the light reflector on a display surface where an image is to be displayed in a first direction, and scans in a second direction perpendicular to the first direction at a speed lower than a scanning speed of the first direction;
an amplitude changing unit which changes an amplitude of the swing of the light reflector; and
a light emitting control unit which adjusts a light emitting timing of the light emitting unit and an amount of light emitted from the light emitting unit,
wherein the amplitude changing unit changes the amplitude of the swing of the light reflector, so that a first state where the light is scanned in a first region of the display surface and a second state where the light is scanned on the first region and a second region different from the first region of the display surface are switched over each other, and
wherein the light emitting control unit allows an amount of light per unit area of the first region in the first state and an amount of light per unit area of the first region in the second state to be equalized by adjusting the amount of light emitted from the light emitting unit.

2. The display apparatus according to claim 1, wherein the light emitting control unit allows a resolution of an image displayed on the first region in the first state and a resolution of an image displayed on the first region in the second state to be equalized by adjusting the light emitting timing of the light emitting unit.

3. The display apparatus according to claim 1,
wherein an image displayed in the first region in the first state and an image displayed in the first region in the second state are the same in type, and
wherein the image displayed in the first region and an image displayed in the second region are different from each other in type.

4. The display apparatus according to claim 3,
wherein the image displayed in the first region includes an image representing information on a moving state of a moving body having the display apparatus, and
wherein the image displayed in the second region includes an image representing information on an external situation of the moving body.

5. The display apparatus according to claim 4, further comprising a situation sensing unit which senses the external situation of the moving body,
wherein the amplitude changing unit switches the first state and the second state based on a result of the sensing of the situation sensing unit.

6. The display apparatus according to claim 1, wherein the amplitude changing unit changes an amplitude of the swing of the light reflector which scans the light in the first direction.

7. The display apparatus according to claim 1, wherein the amplitude changing unit changes an amplitude of the swing of the light reflector which scans the light in the second direction.

8. The display apparatus according to claim 1,
wherein the light scanning unit includes a driving unit which swings the light reflector by supplying a periodically varying current or voltage, and
wherein the amplitude changing unit changes an amplitude of the swing of the light reflector by adjusting a magnitude and a frequency of the current or the voltage supplied to the driving unit.

9. The display apparatus according to claim 1, wherein the light emitting unit emits laser beams.
